(19) United States
(12) Patent Application Publication
(10) Pub. No.: US 2008/0294721 A1
(43) Pub. Date: Nov. 27, 2008

(54) ARCHITECTURE FOR TELECONFERENCING WITH VIRTUAL REPRESENTATION

(76) Inventors: Philipp Christian Berndt, Berlin (DE); Paul J. McCabe, Berlin (DE); Matthias Welk, Berlin (DE)

Correspondence Address: HUGH P. GORTLER, 23 ARRIVO DRIVE, MISSION VIEJO, CA, 92692, US

(21) Appl. No.: 11/751,152

(22) Filed: May 21, 2007

(51) Int. Cl. G06F 15/16

(52) U.S. Cl. 709/204

(57) ABSTRACT

A communications system includes a teleconferencing system for hosting teleconferences, and a server system for providing a virtual representation for the teleconferencing system. The virtual representation includes objects whose states can be commanded to transition gradually. The server system provides clients to client devices, and each client causes its client device to display the virtual representation. Each client device is capable of generating a command for gradually transitioning an object to a new state in the virtual representation and sending the command to the server system. The server system commands the clients to transition an object to its new state by a specified time.

### BRIEF DESCRIPTION OF THE DRAWINGS

FIG. 1 is an illustration of a system in accordance with an embodiment of the present invention.

FIG. 2 is an illustration of a method in accordance with an embodiment of the present invention.

FIG. 3 is an illustration of a virtual environment in accordance with an embodiment of the present invention.

FIG. 4 is an illustration of a system in accordance with an embodiment of the present invention.

FIG. 5 is an illustration of a timeline in accordance with an embodiment of the present invention.

FIG. 6 is an illustration of a method of mixing sound in accordance with an embodiment of the present invention.

FIG. 7 is an illustration of audio cut-off in accordance with an embodiment of the present invention.

FIGS. 8 and 9 are illustrations of a method of computing waypoints for a moving object in accordance with an embodiment of the present invention.

FIGS. 10a-10d are illustrations of different topologies for a communications system in accordance with the present invention.

FIG. 11 is an illustration of a system in accordance with an embodiment of the present invention.

### DETAILED DESCRIPTION

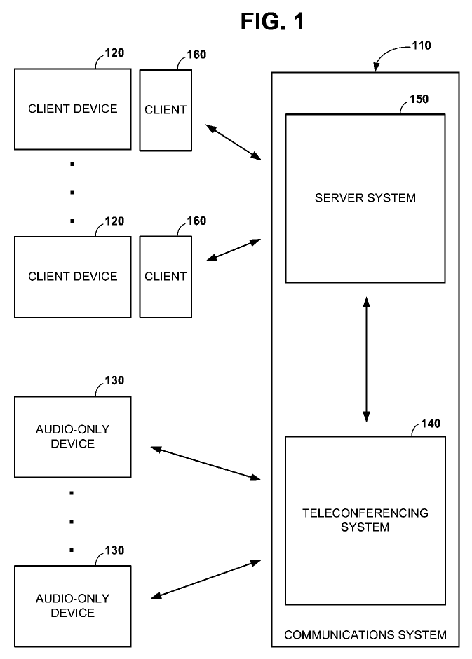

Reference is made to FIG. 1, which illustrates a communications system 110 for providing a communications service to users having client devices 120 and audio-only devices 130. A client device 120 refers to a device that can run a client and provide a graphical interface. An example of a client is a Flash client. Client devices 120 are not limited to any particular type. Examples of client devices 120 include, but are not limited to computers, tablet PCs, VOIP phones, gaming consoles, televisions with set-top boxes, certain cell phones, and personal digital assistants. Another example of a client device 120 is a device running a Telnet program.

Audio-only devices 130 refer to devices that provide audio but, for whatever reason, cannot display a virtual representation (a virtual representation is described below). Examples of audio-only devices 130 include traditional phones (e.g., touch-tone phones) and VOIP phones.

The term “user” refers to an entity that utilizes the communications system 110. The entity could be, for example, an individual.

The communications system 110 includes a teleconferencing system 140 for hosting teleconferences. The teleconferencing system 140 may include a phone system for establishing phone connections with traditional phones (landline and cellular), VOIP phones, and other audio-only devices 130. For example, a user of a traditional phone can connect with the teleconferencing system 140 by placing a call to it. The teleconferencing system 140 may also include means for establishing connections with client devices 120 that have teleconferencing capability (e.g., a computer equipped with a microphone, speakers and teleconferencing software).

A teleconference is not limited to conversations between two users. A teleconference can involve many users. Moreover, the teleconferencing system 140 can host one or more teleconferences at any given time.

The communications system 110 further includes a server system 150 for providing a virtual representation for the teleconferencing system 140. A virtual representation provides a vehicle by which a user can enter into a teleconference (e.g., initiate a teleconference, join a teleconference already in progress), even if that user knows no other users represented in the virtual representation. The communications system 110 allows a user to listen in on one or more teleconferences. A user then has the option of joining a teleconference. Even while engaged in one teleconference, a user has the ability to listen in on other teleconferences, and seamlessly leave the one teleconference and join another teleconference. A user could even be involved in a chain of teleconferences (e.g., a line of people where person C hears B and D, and person D hears C and E, and so on).

The server system 150 provides clients 160 to those users having client devices 120. Each client 160 causing its client device 120 to display a virtual representation.

A virtual representation is not limited to any particular number of dimensions. A virtual representation could be depicted in two dimensions, three dimensions, or higher.

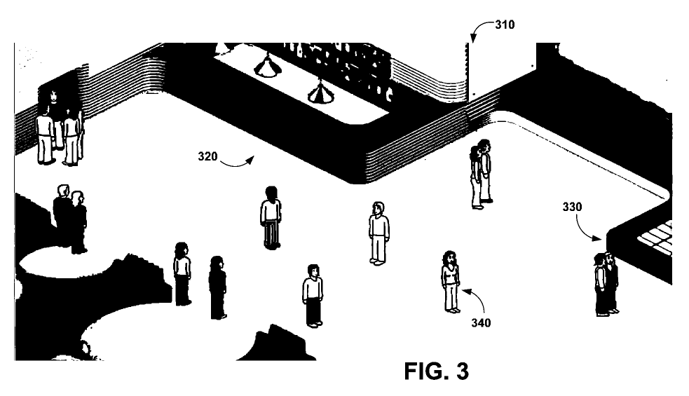

A virtual representation is not limited to any particular type. As first type of virtual representation could be similar to the visual metaphorical representations illustrated in FIGS. 3-5 and 8a-8b of Singer et al. U.S. Pat. No. 5,889,843 (a graphical user interface displays icons on a planar surface, where the icons represent audio sources).

A second type of virtual representation is a virtual environment. A virtual environment includes a scene and (optionally) sounds. A virtual environment is not limited to any particular type of scene or sounds. As a first example, a virtual environment includes a beach scene, with blue water, white sand and blue sky. In addition, the virtual environment includes an audio representation of a beach (e.g. waves crashing against the shore, sea gulls cries). As a second example, a virtual environment provides a club scene, complete with bar, dance floor, and dance music (an exemplary bar scene 310 is depicted in FIG. 3).

A virtual representation includes objects. Users of the communications system 110 are represented by at least some of these objects. The representations of users could be images, avatars, live video, recorded sound samples, name tags, logos, user profiles, etc. In the case of avatars, live video or photos could be projected on them. The user representations allow their users to see and communicate with other users in a virtual representation. In some situations, the user cannot see his own representation, but rather sees the virtual representation as his representation would see it (that is, from a first person perspective).

Objects representing users may have states that change gradually. For instance, an avatar has states such as location and orientation. The avatar can walk (that is, make a gradual transition) from its current location (current state) to a new location (new state).

Each client 160 enables its client device 120 to move the user's representation within the virtual representation. By moving his representation around a virtual representation, a user can listen in on teleconferences, and approach and meet different users. By moving his representation around a virtual environment, a user can experience the sights and sounds that the virtual environment offers.

Other objects in a virtual representation might have states that transition gradually or abruptly. A user can also interact with a virtual representation by changing the states of these other objects. As a first example, a user can take part in a virtual volleyball game. Hitting a volleyball would cause the volleyball to follow a path towards a new location. As a second example, a user blows up a balloon. The balloon starts uninflated (e.g., a current state) and expands gradually to a fully inflated size (e.g., a new state).

A virtual environment may be “immersive.” An “immersive” virtual environment is defined herein as an environment with which a user can interact.

Additional reference is made to FIG. 3, which depicts an exemplary virtual environment including a club scene 310. The club scene 310 includes a bar 320, and dance floor 330. A user is represented by an avatar 340. Other users in the club scene 310 are represented by other avatars. Dance music is projected from speakers (not shown) near the dance floor 330. As the user's avatar 340 approaches the speakers, the music heard by the user becomes louder. The music is loudest when the user's avatar 340 is in front of the speakers. As the user's avatar 340 is moved away from the speakers, the music becomes softer. If the user's avatar 340 is moved to the bar 320, the user hears background conversation (which might be actual conversations between other users at the bar 320). The user might hear other background sounds at the bar 320, such as a bartender washing glasses or mixing drinks. Audio representation might involve changing the speaker's audio characteristics by applying filters (e.g. reverb, club acoustics). An avatar could be moved from its current location to a new location by clicking on the new location in the virtual environment, pressing a key on a keyboard, pressing a key on a telephone, entering text, entering a voice command, etc.

The user might not know any of the other users represented in the club scene 310. However, the user can cause his avatar 340 to approach another avatar to enter into a teleconference with that other avatar's user (as described below, the users can start speaking with each other as soon as both avatars are within audio range of each other). Users can use their audio-only devices 130 to speak with each other (each audio-only device makes a connection with the teleconferencing system 140, and the teleconferencing system completes the connection between the audio-only devices). The user can command his avatar 340 to leave that teleconference, wander around the club scene 310, and approach other avatars so as to talk to other people and to listen to other conversations between other people. The user can then join in on those other conversations.

A virtual representation and a teleconference are generated by two different systems 140 and 150. In addition, the different clients 160 that display the virtual representation might not communicate directly with each other (in a pure client-server system, they won't). Yet the communication system 110 ensures that the clients 160 display roughly the same object transitions in a virtual representation at roughly the same time.

If a user commands a new object state in a virtual representation, his client does not directly inform other clients of the new state. Moreover, the client does not immediately transition the object to the new location. Instead, the client sends a request to the server system 150 and awaits instructions from the server system 150.

The server system 150 causes all of the clients displaying a virtual representation to gradually transition an object to its new state by a specified time. When a state of an object in an environment has changed, the server system 150 informs all necessary clients of the change. In this manner, the server system 150 ensures that all client devices 120 show roughly the same object transition in the virtual representation at roughly the same time.

The communications system 110 can host multiple virtual representations simultaneously. The communications system 110 can host multiple teleconferences in each virtual representation.

If more than one virtual representation is available to a user, the user can move in and out of the different virtual representations. Each of the virtual representations can be uniquely addressable via an Internet address or a unique phone number. The server system 150 can then place each user directly into the selected virtual representation. Users can reserve and enter private virtual representations to hold private conversations. Users can also reserve and enter private areas of virtual representations to hold private conversations. A web browser or other graphical user interface could include a sidebar or other means for indicating different virtual representations that are available to a user.

Thus, a user can make use of both a client device 120 and an audio-only device 130 during a teleconference. The client device 120 is used to interact with the virtual representation and find others to speak with. The audio-only device 130 is used to speak with others.

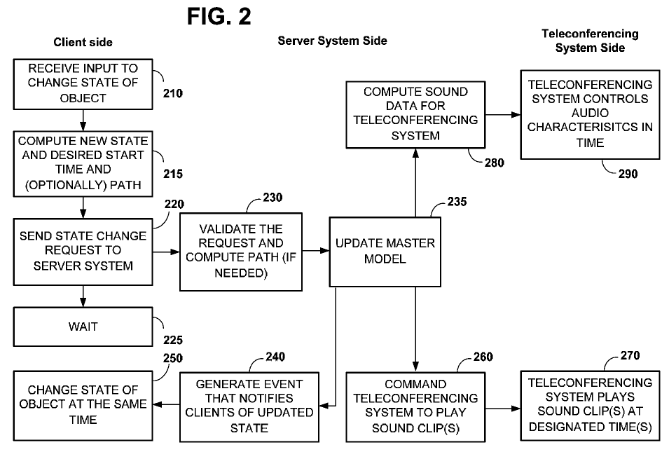

Additional reference is made to FIG. 2, which illustrates an example of how the communications system 110 manages the state of an object when a client device requests a new state for that object. To further illustrate this example, the object will be described as an avatar that represents a user, and the new state will be a new location of the avatar.

On the client side, the client receives an input to change the state of the object (block 210). For example, the new location for an object is received by clicking on the new location in the virtual representation.

In response, the client 160 computes coordinates in the virtual representation from the clicked screen coordinates of the new location (block 215) and sends a state change request to the server system (block 220). The state change request includes the coordinates of the new location. The state change request may also include a desired time at which the avatar should start moving toward the new location (block 215). The desired time should be slightly in the future so that an event can be communicated to all clients 160 before the time arrives. Then, the client 160 goes into a wait state (block 225).

The server system 150 validates the request (block 230). For example, the server system 150 checks whether the virtual representation contains a path that allows the avatar to move to the new location. This may include determining whether the coordinates of the new location lie within a walkable space and whether the avatar is allowed to walk there from its current location at the specified time. If the time has already passed or doesn't allow time to communicate, the starting time is shifted slightly into the future as necessary.

If the request is validated, the server system 150 can also compute a path and arrival time for the representation to transition from the current state to the new state (block 230). For example, the server system 150 may use a wayfinding algorithm to compute a walking route with waypoints and arrival times for each waypoint. An exemplary wayfinding algorithm is described below.

The server system 150 updates a master model, which is a data structure that contains all object states in time (block 235). For example, the server system 150 adds the avatar's waypoints and their arrival times to the master model.

The server system 150 then generates an event, which notifies all clients 160 of the updated object state (block 240). For example, the event includes the start and stop times for each waypoint in the avatar's walking path. All of those clients 160 displaying the virtual representation will move the avatar to each of the waypoints at the same arrival times. Thus, all of those clients 160 will shows roughly the same avatar motion at roughly the same time (roughly, due, for instance, to imperfectly synchronized system clocks or system latencies).

In addition, the server system 150 can command the teleconferencing system 140 to play movement sounds at the appropriate time (block 260). The teleconferencing system 140 plays the sound clip(s) at the designated time(s) (block 270). For example, the server system 150 can provide a sound clip of the sound of footsteps as an avatar walks to a new location, and the teleconferencing system 140 plays the sound clip to the user whose avatar is walking.

The server system 150 also synchronizes the sound clips with the movement and state changes in the virtual representation.

The server system 150 can also generate data for controlling audio characteristics over time (block 280). For example, volume of a conversation between two users is a function of distance and/or orientation of their two avatars in the virtual environment. In this example, sound gets louder as the avatars move closer together, and sound gets softer as the avatars move further apart. The server system 150 generates sound coefficients that vary the volume of sound between two users, as a function of the distance between the two users. The coefficients are used by the teleconferencing system 140 to vary sound volume over time (block 290). In this manner, the server system 150 commands the teleconferencing system 140 to attenuate or modify sounds so the conversation is consistent with the virtual environment. In this manner, the server system 150 can also command the teleconferencing system 140 to play sound clips, record user speech or modify operational parameters affecting sound quality.

In general, an object in a virtual representation has properties that allow a user to perform certain actions on them (e.g. sit on, move, open). An object (e.g. a Flash object) obeys certain specifications (e.g. an API). As but one example, an object can be a jukebox having methods (actions) such as play/stop/pause, and properties such as volume, song list, and song selection. The server system 150 would generate an event when the jukebox is turned on and a song selected. The server system 150 would command the teleconferencing system to play the selected clip.

A client 160 can optionally compute a transition path at block 215 and send the transition path to the sever system 150. This might be done to ease the workload (at block 230) on the server system 150, which wouldn't have to compute the transition path.

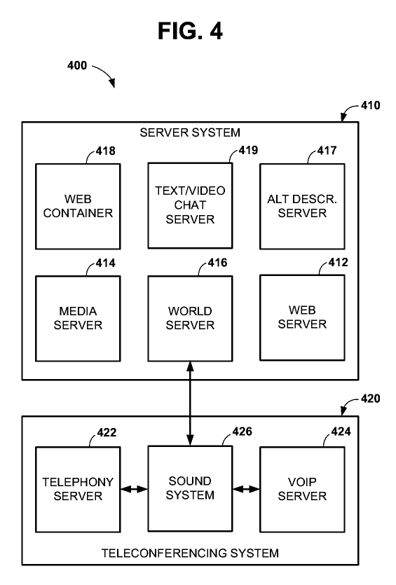

Reference is made to FIG. 4, which illustrates an exemplary web-based communications system 400. The communications system 400 includes a VE server system 410. The “VE” refers to virtual environment.

The VE server system 410 hosts a website, which includes a collection of web pages, images, videos and other digital assets. The VE server system 410 includes a web server 412 for serving web pages, and a media server 414 for storing video, images, and other digital assets.

One or more of the web pages allow users to access the web site. One or more of the web pages embed client files. Files for a Flash client, for instance, are made up of several separate Shockwave Flash Objects (.swf files) that are served by the web server 412 (some of which can be loaded dynamically when they are needed).

A client is not limited to a Flash client. Other browser-based clients include, without limitation, Java applets, Microsoft Expression Blend/Silverlight/Sparkle, .NET applets, Shockwave clients, scripts such as JavaScript, etc. A downloadable, installable program could even be used.

Using a web browser, a client device downloads web pages from the web server 412 and then downloads the embedded client files from the web server 412. The client files are loaded into the client device, and the client is started and loads the remaining parts of the client files (if any) from the web server 412.The client starts running or parsing the client files.

“Providing a client” means providing an entire client or a portion thereof. Consider the example of a Flash client including a Flash player and one or more Shockwave Flash Objects The Flash player is already installed on a client device. “Providing a client” in this example involves sending .swf files to the Flash player. With the .swf files are loaded, the Flash player becomes a virtual machine that causes the client device to display a virtual environment. The virtual machine also accepts inputs (e.g., keyboard inputs, mouse inputs) that command the user representation to move about and experience the virtual environment.

The server system 410 also includes a world server 416. As used herein, the “world” refers to all virtual representations provided by the server system 410. When a client starts running, it opens a connection with the world server 416. The server system 410 selects a description of a virtual environment and sends the selected description to the client. The selected description contains links to graphics and other media for the virtual environment. The description also contains coordinates and appearances of all objects in the virtual environment. The client loads media (e.g., images) from the media server 414, and projects the images in isometric, 3-D.

The client displays objects in the virtual environment. Some of these objects are user representations such as avatars. The animated views of an object could comprise pre-rendered images or just-in-time rendered 3D-Models and textures, that is, objects could be loaded as individual Shockwave Flash Objects, parameterized generic Shockwave Flash Objects, images, movies, 3D-Models optionally including textures and animations. Users could have unique/personal avatars or share generic avatars.

Objects can be loaded on demand, which reduces the initial loading time. Also low quality or generic representations could be loaded first, for example, when an avatar is far away from another object, and higher quality representations could be loaded later, as the avatar gets closer to the object.

When a client device wants an object to move to a new location in the virtual environment, its client determines the coordinates of the new location and a desired time to start moving the object, and generates a request. The request is sent to the world server 416.

The world server 416 receives a request and updates the data structure representing the “world.” The world server 416 keeps track of each object state in each virtual environment, and updates the states that change. Examples of states include avatar state, objects they're carrying, user state (account, permissions, rights), and call management. When a user commands an object in a virtual environment to a new state, the world server 416 commands all clients represented in the virtual environment to transition the state of that object, so client devices 120 display the object at roughly the same state at roughly the same time.

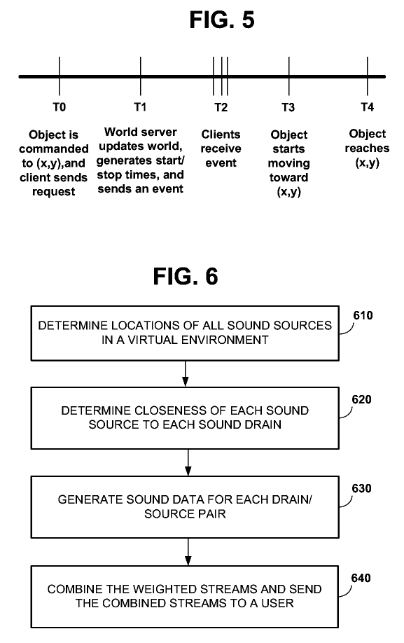

Reference is now made to FIG. 5. An event may specify destination coordinates, and start and stop times for an object. All clients begin moving the object toward the desired coordinates at the start time, and all clients have the object at the new coordinates at the stop time. This approach is illustrated by an exemplary timeline in FIG. 5. At time T0, a user commands an object to move to new coordinates (x,y) and sends the new coordinates to the world server 416. At time T1, the world server 416 receives the new coordinates, and computes start and end times T3 and T4, generates an event containing the times and coordinates (x,y), and sends it to all clients viewing the same virtual environment. Around time T2, subject to individual network delays, the clients receive the event (represented by the multiple lines at time T2). At time T3, each client starts moving the object toward the new location and controls the rate of motion such that the object will reach the new location by time T4.

Due to latency in the system, a client device might receive the start and stop times after time T3. If this happens, that client device can increase the rate of motion so the representation reaches the new location at time T4.

In some embodiments, a client may anticipate the response event from the VE server system 410 and tentatively start moving the avatar either as soon as the user gives the command or at the point in time when the world server 416 is believed to receive the request or at the point in time when the world server 416 is believed to have received the request. The other clients would wait for an event from the world server 416.

The world server 416 can also keep track of objects that transition abruptly. When a client device commands an object to transition abruptly to a new state, the world server 416 receives the command and generates an event that causes all of the clients to show the object at the new state at a specified time.

The communications system 400 also includes a teleconferencing system 420, which allows users represented in a virtual environment to hold teleconferences. The teleconferencing system 420 may include a telephony server 422 for establishing calls with traditional telephones. For instance, the telephony server 422 may include PBX or ISDN cards for making connections for users who call in with traditional telephones (e.g., touch-tone phones) and digital phones. The telephony server 422 may include mobile network or analog network connectors. The cards act as the terminal side of a PBX or ISDN line and, in cooperation with associated software perform all low-level signaling for establishing phone connections. Events (e.g. ringing, connect, disconnect) and audio data in chunks (of e.g. 100 ms) are passed from a card to a sound system 426 as described below. The sound system 426, among other things, mixes the audio between users in a teleconference, mixes any external sounds (e.g., the sound of a jukebox, a person walking, etc) and passes the mixed (drain) chunks back to the card and, therefore, to a user.

The teleconferencing system 420 may include a VOIP server 424 for establishing connections with users who call in with VOIP phones. In this case, a client may contain functionality by which it tries to connect to a VOIP soft-phone audio-only device using, for example, an xml-socket connection. If the client detects the VOIP phone, it enables VOIP functionality for the user. The user can then (e.g., by the click of a button) cause the Flash client to establish a connection by issuing a CALL command via the socket to the VOIP phone 130 which calls the VOIP server 424 while including information necessary to authenticate the VOIP connection.

The world server 416 associates each authenticated VOIP connection with a client connection. The world server 416 associates each authenticated PBX connection with a client connection.

The sound system 426 can mix sounds of the virtual environment with audio from the teleconferencing. Consider the example in FIG. 5. At time T3, the sound system 426 may start playing a walking sound. Between times T3 and T4, sound coefficients vary over time and the sound system 426 uses those coefficients to vary the sound characteristics for other objects relative to the walking avatar. For instance, the walking sound will become louder to a stationary avatar as the walking avatar walks towards it. Between times T3 and T4, the world server 426 may periodically send coefficient updates to the sound system 426 or may beforehand send instructions how to vary the coefficients between T3 and T4 (or a mixture of both). At time T4, the walking sound is stopped. In this manner, the sound of footsteps could be by synchronized with the avatar.

Sound mixing is not limited to any particular approach. Approaches are described below.

The world server 416 can also indicate whether users of representations are voice-enabled and in conversation. A telephone icon over the head of an avatar could be used to indicate that its user is voice-enabled, and/or another graphical sign, such as sound waves, could be displayed near an avatar (e.g. in front of its face) to indicate that it is speaking or making other sounds.

The VE server system 410 may also include one or more servers that offer additional services. For example, a web container 418 might be used to implement servlet and the JavaServer Pages (JSP) specifications to provide an environment for Java code to run in cooperation with the web server 412.

The VE server system 410 may also include one or more servers 419 for webcam data and text messaging. These servers 419 could receive webcam data or text messages from different users, and associate the webcam data and text messages with the different users such that a user's webcam data and text messages can be viewed by certain other users. The world server 416 could determine whether one user can view camera data or text messages from another user as a function of closeness to that other user.

All servers in the communications system 400 can be run on the same machine, or distributed over different machines. Communication may be performed by a remote invocation call. For example, an HTTP or HTTPS-based protocol (e.g. SOAP) can be used by the server and network-connected devices to transport the clients and communicate with the clients.

Reference is made to FIG. 6, which illustrates a first approach for mixing sound. The world server 416 generates data such as sound coefficients, which the sound system 426 uses to vary the audio characteristics (e.g., audio volume). The sound coefficients or other data vary the audio volume or other audio characteristics as a function of closeness of object pairs.

At block 610, locations of all sounds sources in a virtual environment are determined. Sound sources include objects in a virtual environment (e.g., a jukebox, speakers, a running stream of water). Sound sources also include those users who are talking. A sound source could be multimedia from an Internet connection (e.g., audio from a YouTube video).

The following functions are performed for each drain in the virtual environment. A drain refers to the representation of a user who can hear sounds in the virtual environment. At block 620, closeness of each sound source to a drain is determined. This function is performed for each sound drain in the virtual environment. The closeness is not limited to distance. The world server 416 can perform this function, since it maintains the information about location of the sound sources.

At block 630, a coefficient for each drain/source pair is generated. Each coefficient varies the volume of sound from a source as a function of its closeness to the drain. This function may also be performed by the world server 416, since it maintains information about locations of the objects. The world server 416 supplies the sound coefficients to the sound system 426.

The sound from a source to a drain can be cut off (that is, not heard) if the source is outside of the audio range of the drain. The coefficient would reflect such cut-off (e.g., by being set to zero or close to zero). The world server 416 can determine the range, and whether cut-off occurs, since it keeps track of the object states.

At block 640, audio streams from the audio sources are weighted as a function of closeness to the drain, and the weighted streams are combined and sent back on a phone line or VOIP channel to a user. The sound system 426 may include a processor that receives a list of patches, sets of coefficients, and goes through the list. The processor can also use heuristics to determine whether it has enough time to patch all connections. If not enough time is available, packets are dropped.

Reference is now made to FIG. 7. The world server 416 may also determine an acoustic range for each object. The acoustic ranges are used to determine whether sound is cut off. A user's representation is at location P_{W} and the representations of three other users are at locations P_{X}, P_{Y} and P_{Z}. Audio ranges of the representations at locations P_{W} and P_{Z} are indicated by circles E_{W} and E_{Z}. Audio ranges of the representations at locations P_{X} and P_{Y} are indicated by ellipses E_{X} and E_{Y}. The elliptical range indicates that the sound from these audio sources is directional.

The audio range may be a receiving range or a broadcasting range. If a receiving range, a user will hear other sources within that range. Thus, the user will hear other users whose representations are at locations P_{X} and P_{Y}, since the audio ranges E_{X} and E_{Y} intersect the range E_{W}. The user will not hear the person whose representation is at location P_{Z}, since the audio range E_{W} does not intersect the range E_{Z}.

If the audio range is a broadcasting range, a user hears those sources in whose broadcasting range he is. Thus, the user will hear the person whose representation is at location P_{X}, since location P_{W} is within the ellipse E_{X}. The user will not hear the people whose representations are at locations P_{Y} and P_{Z}, since the location P_{W} is outside of the ellipses E_{Y} and E_{Z}.

The cut-off information is updated by the world server 416, since the locations P_{W}, P_{X}, P_{Y} and P_{Z} can change at any given time.

In addition to or instead of sound mixing illustrated in FIG. 6, to preserve computing power and decrease latencies, the teleconferencing system 420 could switch together source/drain pairs to direct connections. This might be done if the world server 416 determines that two users can essentially only hear each other. Also the teleconferencing system 420 could premix some or all sources for several drains whose coefficients are similar. In the latter case each user's own source may have to be subtracted from the joined drain to yield his drain.

The telephony system 422 (see FIG. 4) can also allow users of audio-only devices to control objects in a virtual environment, and move from one virtual environment to another. A user with only an audio-only device can experience sounds of the virtual environment as well as speak with others, but cannot experience sights of the virtual environment. The telephony system 422 can use phone signals (e.g., DTMF, voice commands) from phones to control the actions of their corresponding representation in the virtual environment.

Certain buttons on a phone can correspond to commands. A user with a touch phone or DTMF-enabled VOIP phone can execute a command by entering that command using DTMF tones. Each command can be supplied with one or more arguments. An argument could be a phone number or other number sequence. In some embodiments, voice commands could be interpreted and used.

A command argument might expect a value from a list of options. The options may be structured in a tree so that the user selects a first group with one digit and is then presented the resulting subsets of remaining options and so on. The most probable options could be listed first.

For example a user could press ‘0’ to enter a command menu where all available commands are read to the user. The user can then enter a CALL command (e.g., 2255) followed by the # sign. The user may then be asked to identify the person to call, e.g., by saying that person's name, entering that person's phone number, entering a code corresponding to that person, etc.

Another command could cause an avatar to move within its virtual environment. Arguments of that command could specify direction, distance, new location, etc. Another command could allow a user to switch to another virtual environment, and an argument of that command could specify the virtual environment. Another command could allow a user to join a teleconference. Another command could allow a user to request information about the environment or about other users. Another command could allow one user's avatar to take another user's avatar by the hand, whereby the latter avatar would follow (be piggybacked to) the former avatar.

For devices that are enabled to run Telnet sessions, a user could establish a telnet session to receive information, questions and options, and also to enter commands.

Certain client devices could include Braille terminals. Braille devices can be used like text terminals.

For users that have only audio-only devices, the server system 410 could include means 417 for providing an alternative description of virtual environment. For Telnet-enabled devices, the means 417 could provide a written description of a virtual environment. For other audio-only devices, the system could include a speech synthesis system for providing a spoken description, which is heard on the audio-only device.

For example, a virtual environment can be described to a user from the perspective of the user's avatar. Objects that are closer to the user's avatar might be described in greater detail. The description may include or leaves out detail to keep the overall length of the description approximately constant. The user can request more detailed descriptions of certain objects, upon which additional details are revealed.

The communications system 410 provides teleconferencing without requiring the user to install software or to acquire special equipment (e.g., microphone, PC speakers, headset). If the system 410 is web-based, a web browser can be used to connect to the VE server system 410, download and run a client, and display the virtual environment. This makes it easy to connect and use the communications system 400.

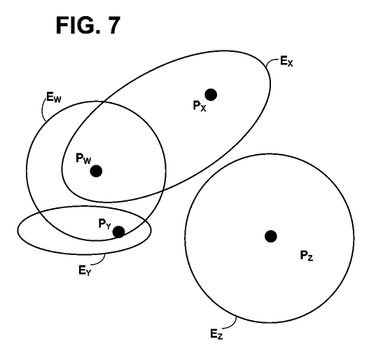

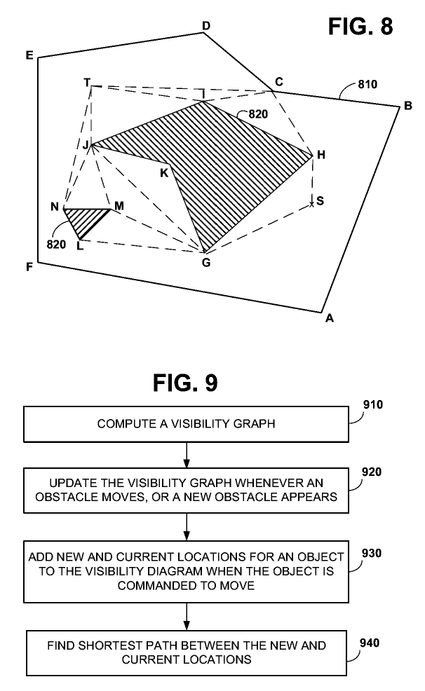

FIGS. 8 and 9 illustrate a method of computing waypoints for a moving object. This method may be performed by the world sever 416. Consider the exemplary space illustrated in FIG. 8. The space is represented by a polygonal boundary 810 and two polygonal obstacles 820. The boundary 810 has vertices A, B, C, D, E and F. One obstacle 820 has vertices G, H, I, J and K, and the other obstacle 820 has vertices L, M and N. The boundary 810 might delineate the bounds of a virtual representation, whereas the obstacles 820 might represent movable objects and fixtures in the virtual representation. The goal of the method is to a find a path from a current location S to a new location T that is not obstructed by either the boundary 810 or the obstacles 820.

A line segment is obstructed by the boundary 810 if any portion of the line segment lies outside the boundary 810. A line segment is obstructed by an obstacle 820 if any portion of the segment lies inside the corresponding open polygon 820.

The path may be formed by one or more line segments (i.e., a piecewise linear path). Internal vertices (i.e. excluding S and T) of the path are vertices of the boundary 810 and obstacle(s) 820. Vertices such as K are excluded as internal vertices, since a path formed by line segment GJ is shorter than a path formed by line segments GK and KJ. Vertices such as A, B, D, E and F are also excluded as internal vertices, since shorter paths can be formed with other vertices. A path could even follow a boundary (e.g., a line segment along vertices H and I).

Referring to FIG. 9, the world server computes a visibility graph (block 910), for example, using a Planar sweep algorithm. The visibility graph includes vertices of the boundary 810 and vertices of each obstacle 820. Between each pair of points, the visibility graph also includes an edge, but only if the line segment is not obstructed by the boundary 810 or by any obstacle 820.

The visibility graph is updated whenever an obstacle 820 moves, or a new obstacle appears (block 920). For instance, the visibility graph is updated if a new avatar enters a virtual representation, or if an object (e.g., a chair) in a virtual environment is moved.

When an object is commanded to move, new and current locations for an object are added to the visibility diagram (block 930), and the shortest path between the new and current locations is found (block 940). An algorithm such as Dijkstra's algorithm may be run on the visibility graph to identify the edges of the shortest path.

At any given time, multiple objects might be moving within a virtual representation. The shortest path determination (block 940) can also include collision avoidance. One approach toward avoiding collisions between two moving objects is to transport each object instantly to its new location. However, collision avoidance is optional, as objects could be allowed to collide (e.g., pass through each other).

As mentioned above, a system according to the present invention is not limited to a single virtual representation. Rather, a system according to the present invention can host a plurality of independent virtual representations, assign different users to different representations, allow one or more teleconferences per virtual representation, and manage the state of (e.g., regulate motion of) the objects in each virtual representation. For example, a system could provide a first virtual environment including a club scene, and a second virtual environment including a beach scene. Some users could be assigned to the first virtual environment, experience sights and sounds of the club scene, and have teleconferences with those users represented by avatars in a virtual club. Other users could be assigned to the second virtual environment, experience sights and sounds of the beach scene, and have teleconferences with those users represented by avatars on a virtual beach. The server system would manage objects in both environments.

The server system can filter communications with the clients, sending communications only to those clients needing to change the state of an object in a particular virtual representation. The world server 416 may perform either or both of the following functions:
(1) Create sessions, handle session timeouts, and destroy sessions. For instance, once a client is closed and the timeout has passed that user's session is terminated.
(2) Dispatch events from the world server 416 to only those clients that will be affected by the events. For instance users in one virtual environment are not affected by events in another virtual environment. Therefore, the world server 416 sends events affecting a virtual environment only to those clients represented in that virtual environment.

The filtering reduces communication overhead. As a result, traffic between the world server and clients is reduced.

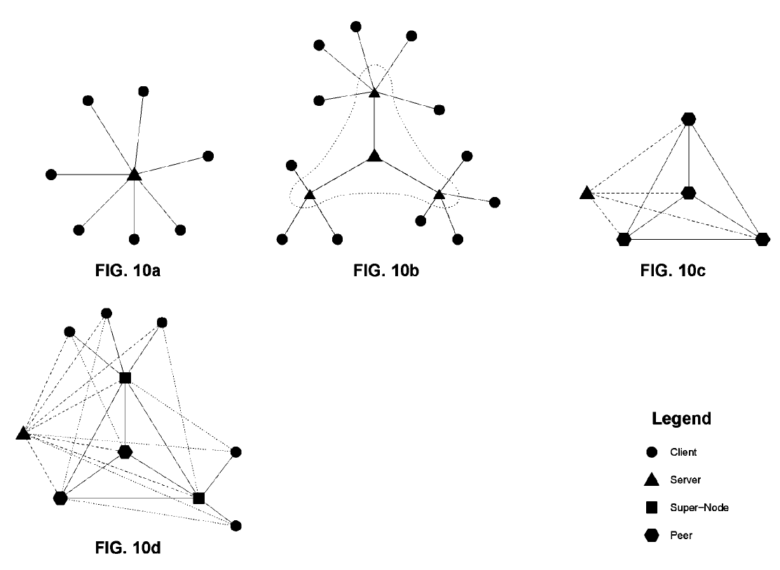

A communications system according to the present invention is not limited to any particular topology. Several exemplary topologies are illustrated in FIGS. 10a-10d. These topologies offer different ways in which clients can communicate with a server system. These FIGS. 10a-10d do not illustrate topologies in which audio-only devices communicate with a teleconferencing system.

Reference is made to FIG. 10a, which illustrates a pure client-server topology. Clients are represented by circles, and a server system is illustrated by a triangle. The server system may include one or more servers.

Reference is now made to FIG. 10b, which illustrates a topology including clients (represented by circles), a server system (represented by a triangle), and super nodes (represented by squares). Each super node functions as both a client and server. Functioning as a server, a super node serves data to all connected clients. Functioning as a client, a super node can display and interact with a virtual representation. The server system and super nodes coordinate to keep track of the objects in a virtual representation. The super nodes may be operated by users or by the communications service provider.

Reference is now made to FIG. 10c, which illustrates a topology including peers (represented by hexagons), and a server system (represented by a triangle). Each peer connects to the server system, as indicated by a dashed line, to display and interact with a virtual representation. However, the peers are also interconnected, as indicated by the solid lines, and as such, can bypass the server system and pass certain data among themselves. Example of such data include, but are not limited to, audio files (e.g., sound clips), static files (e.g., background images, user pictures), live data (e.g. webcam). One of the peers can originate such data and/or receive such data from the server system, and pass the data to its peers.

To ease the burden off the server system, the peers can also exchange data concerning a virtual environment as well as object commands. A transition path and times could be computed by a peer that commanded an object state change, and the path and times could be distributed to its peers. Such data could also be sent to the server system, so the server system can keep track of the objects in the virtual representation.

Reference is now made to FIG. 10d, which illustrates a topology including a server system (represented by a triangle), clients (represented by circles), and peers (represented by hexagons). Peers exchange data among each other, and clients connect to one or more peers (both illustrated with solid lines). If such a connection fails, a client can connect to a fall-back peer (illustrated by dotted lines). The clients and the peers may also connect or exchange data with the server system, as illustrated by the dashed lines.

The topology of FIG. 10d offers advantages of peer-to-peer communication, including reducing computational load and traffic on the server while still allowing simple clients to participate. In contrast to a client that runs in a virtual machine, a peer or super node might require installation.

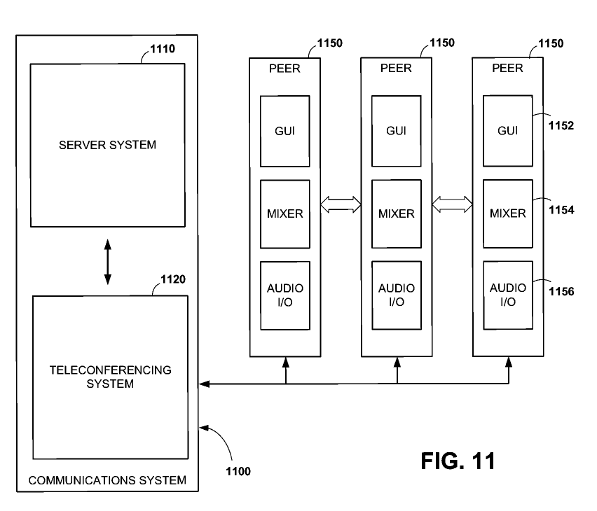

Reference is made to FIG. 11, which illustrates an exemplary communications system 1100 including a server system 1110 and teleconferencing system 1120 that communicate with peers 1150. The server system 1110 provides a virtual representation to each peer 1150, and ensures that each peer 1150 displays roughly the same object transitions at roughly the same time.

The peers 1150 use peer-to-peer communication to exchange data among each other. Each peer 1150 includes a graphical user interface 1152, a sound mixer 1154, and audio input/output hardware 1156 (e.g., a microphone and speakers). Each peer 1150 can generate an audio stream with the audio I/O hardware 1156 and distribute that audio stream to one or more other peers 1150. The sound mixer 1154 of a peer 1150 weights the audio streams from other peers and audio streams from other audio sources. The weighted streams are combined in the sound mixer 1154, and the combined stream is outputted on the audio I/O hardware 1156. Sound coefficients for weighting the audio streams could be computed by a peer's graphical user interface 1152 or by the server system 1110. Peers 1150 could also send combined audio streams to other peers to preserve bandwidth.

Peer communication can also be used to exchange data such as files and events instead of, or in addition, to loading it from the server system 1110. A peer-to-peer file sharing protocol such as Bittorrent can be used to transport static files. This reduces traffic on the server system's media servers because optimally each file is downloaded only once from the server system 1110.

Each user's media (e.g. representation/avatar graphics, profile pictures, files) could be seeded from the user's peer 1150 and distributed among the peers 1150. State change commands, text messages and webcam data or pictures could also be loaded from the server system 1110 only once and distributed in a peer-to-peer fashion to reduce traffic on the server system 1110.

1. A communications system comprising:
a teleconferencing system for hosting teleconferences; and
a server system for providing a virtual representation for the teleconferencing system, the virtual representation including objects whose states can be commanded to transition gradually, the server system providing clients to client devices, each client causing its client device to display the virtual representation;
each client device capable of generating a command for gradually transitioning an object to a new state in the virtual representation and sending the command to the server system;
the server system commanding the clients to transition an object to its new state by a specified time.

2. The communications system of claim 1, wherein the server system causes the teleconferencing system to control audio characteristics in a manner that is consistent with the virtual representation.

3. The communications system of claim 1, wherein the teleconferencing system includes a phone system.

4. The communications system of claim 1, wherein when a client device commands an object to transition gradually to a new state, the server system receives the command and generates an event that commands all of the clients to transition the object to the new state by a specified time.

5. The communications system of claim 4, wherein the server system also keeps track of objects that transition abruptly; and wherein when a client device commands an object to transition abruptly to a new state, the server system receives the command and generates an event that commands all of the clients to show the object at the new state at a specified time.

6. The communications system of claim 1, wherein at least some of the objects are movable and represent users.

7. The communications system of claim 1, wherein the virtual representation is an immersive virtual environment.

8. The communications system of claim 1, wherein the server system manages a master model of object states in time so as to regulate state transitions of the objects in the virtual representation.

9. The communications system of claim 8, wherein the server system, in response to a command, determines a first time at which an object should start transitioning from a current state and a second time at which the should object reach the new state; and wherein the server system sends start and stop times and the new state to the clients.

10. The communications system of claim 9, wherein the server system also computes a movement path including waypoints and arrival times at the waypoints, and sends the movement path to the clients.

11. The communications system of claim 8, wherein a client computes a transition path and sends the transition path to the server system.

12. The communications system of claim 1, wherein the server system is web-based.

13. The communications system of claim 1, wherein the clients are run on virtual machines.

14. The communications system of claim 13, wherein the clients are Flash clients.

15. The communications system of claim 1, wherein the teleconferencing system includes a VOIP system for establishing VOIP with network-connected devices.

16. The communications system of claim 1, further comprising a sound system for generating sounds for objects in the virtual representation, wherein the server system also synchronizes the objects in the virtual representation with the sounds; and wherein the sound system mixes the synchronized sounds with audio from a teleconference.

17. The communications system of claim 1, wherein the server system includes a world server for generating data for varying audio characteristics in time of audio between users during a teleconference.

18. The communications system of claim 1, wherein the virtual representation is a virtual environment, and wherein the communications system further comprises means for allowing audio-only devices to control objects in the virtual environment.

19. The communications system of claim 18, wherein the means responds to phone signals to control the objects in the virtual environment.

20. The communications system of claim 18, further comprising means for providing an audio description of the virtual representation to audio-only devices.

21. The communications system of claim 1, wherein the teleconferencing system hosts multiple teleconferences among different groups of users; wherein the server system provides additional independent virtual representations and regulates state transitions of the objects in each virtual representation; and wherein the server system filters communications with the clients, sending communications only to those clients needing to transition an object in a particular virtual representation.

22. A communications system for a plurality of client devices, comprising:
first means for hosting teleconferences; and
second means for providing virtual representations that enable the teleconferences, each virtual representation including objects whose states transition gradually, the second means providing clients to at least some of the client devices, each client causing its client device to display a virtual representation;
each client device capable of generating a command for gradually transitioning an object to a new state in a virtual representation and sending the command to the second means;
the second means commanding the clients to transition an object to roughly the same state at roughly the same time
the second means causing the first means to control audio characteristics of the teleconferences to be consistent with the virtual representations.

23. A method of providing a communications service, the method comprising:
hosting a teleconference;
providing clients to a plurality of client devices, each client causing its client device to display a virtual representation of the teleconference, the virtual representation including objects whose states transition gradually;
waiting for object state transition commands from a client, each object state transition command for gradually transitioning an object to a new state in the virtual representation; and
generating an event in response to a command, the event causing each of the clients to transition an object to roughly the same state at roughly the same time.
